(19) United States
(12) Patent Application Publication
(10) Pub. No.: US 2008/0309681 A1
(43) Pub. Date: Dec. 18, 2008

(54) DEVICE AND METHOD FOR DRIVING LIQUID CRYSTAL DISPLAY PANEL

(76) Inventors: Wei-Yang Ou, Kao-Hsiung City (TW); Jing-Chi Yu, Hsinchu City (TW); Wen-Chi Wu, Tao-Yuan City (TW); Chi-Mo Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/762,072

(22) Filed: Jun. 13, 2007

(51) Int. Cl. G09G 5/10

(52) U.S. Cl. 345/690

(57) ABSTRACT

A device for driving an LCD panel comprises: a gray level voltage generation circuit, for generating gray level voltages, and determining whether the gray level voltages are generated by utilizing a first set of reference voltages or a second set of reference voltages according to a polarity inversion control signal, where the gray level voltage generation circuit determines whether a gray level voltage is generated by utilizing a maximum of the first set of reference voltages or a maximum of the second set of reference voltages, and determines whether another gray level voltage is generated by utilizing a minimum of the first set of reference voltages or a minimum of the second set of reference voltages; and a source driving circuit, for selecting a gray level voltage according to display data or inverted data of the display data to drive a source of a display cell of the LCD panel.

### BACKGROUND OF THE INVENTION

1. Field of the Invention

The present invention relates to liquid crystal displays (LCDs), and more particularly, to devices and methods for driving LCD panels.

2. Description of the Prior Art

Please refer to FIG. 1. FIG. 1 is a diagram of a device 100 for driving a liquid crystal display (LCD) panel according to the prior art, where the device 100 comprises a gray level voltage generation circuit 110 and a source driving circuit 120. The gray level voltage generation circuit 110 comprises two sets of buffer amplifiers 112-1 and 112-2, respectively receiving a first set of reference voltages VREF_P(1), VREF_P(2), . . . , VREF_P(N−1), and VREF_P(N) and a second set of reference voltages VREF_N(1), VREF_N(2), . . . , VREF_N(N−1), and VREF_N(N), to perform buffering operations and respectively generate corresponding buffered reference voltages at the output ends of respective buffer amplifiers, where the first set of reference voltages correspond to positive polarity while the second set of reference voltages correspond to negative polarity. The gray level voltage generation circuit 110 further comprises two sets of gray level resistors 114-1 and 114-2, and each set of gray level resistors comprise M voltage-dividing resistors arranged in series, where terminals of each resistor are capable of outputting voltages. As a result, according to the buffered reference voltages outputted by the first set of buffer amplifiers 112-1, the first set of gray level resistors 114-1 generate a first set of candidate gray level voltages VP(0), VP(1), . . . , VP(M−1), and VP(M), and, according to the buffered reference voltages outputted by the second set of buffer amplifiers 112-2, the second set of gray level resistors 114-2 generate a second set of candidate gray level voltages VN(0), VN(1), . . . , VN(M−1), and VN(M).

As shown in FIG. 1, the gray level voltage generation circuit 110 further comprises switching units 116-0, 116-1, . . . , and 116-M. According to a polarity inversion control signal POL and its inverted signal POLB, each switching unit 116-i (i=0, 1, . . . , M) selects a candidate gray level voltage as the corresponding gray level voltage V(i) from the candidate voltages VP(M−i) and VN(i). Hence, according to the polarity represented by the polarity inversion control signal POL, one set of the two sets of candidate gray level voltages (i.e., the first set of candidate gray level voltages VP(0), VP(1), . . . , VP(M−1), and VP(M), and the second set of candidate gray level voltages VN(0), VN(1), . . . , VN(M−1), and VN(M)) are selected as gray level voltages V(0), V(1), . . . , and V(M), so that the gray level voltages V(0), V(1), . . . , and V(M) are transmitted to a source driving circuit of each display cell of the LCD panel, such as the source driving circuit 120, where Cload represents an equivalent capacitance of the display cell driven by the source driving circuit 120.

In addition, the source driving circuit 120 comprises a decoder 124 and a buffer 128, where according to display data, the decoder 124 performs selection operations on the gray level voltages V(0), V(1), . . . , and V(M) and outputs a gray level voltage selected from the gray level voltages V(0), V(1), . . . , and V(M), and then a buffering operation is performed by utilizing the buffer 128 to drive the corresponding load within the LCD panel, i.e., the above-mentioned equivalent capacitance Cload.

FIG. 2 illustrates a curve of a function f_{VP} that may have values of the first set of candidate gray level voltages VP(0), VP(1), . . . , VP(M−1), and VP(M) shown in FIG. 1 with respect to the display data, while FIG. 3 illustrates a curve of a function f_{VN} that may have values of the second set of candidate gray level voltages VN(0), VN(1), . . . , VN(M−1), and VN(M) shown in FIG. 1 with respect to the display data, where f_{VP}(i)=VP(M−i) and f_{VN}(i)=VN(i) (i=0, 1, . . . , and M). In this example, the curves of the functions f_{VP} and f_{VN} have similar shapes but the two curves have opposite directions. In addition, with respect to the same display data 0, the function f_{VP} has its own extreme value such as the smallest gray level voltage VP(M) of the positive polarity and the function f_{VN} has its own extreme value such as the greatest gray level voltage VN(0) of the negative polarity, as shown in FIG. 2 and FIG. 3 respectively. Additionally, with respect to the same display data M, the function f_{VP} has its own extreme value such as the greatest gray level voltage VP(0) of the positive polarity and the function f_{VN} has its own extreme value such as the smallest gray level voltage VN(M) of the negative polarity.

As mentioned above, during the process of generating the gray level voltages, the voltage swing between the candidate gray level voltages VP(M−i) and VN(i) switched by the corresponding switching unit 116-i (i=0, 1, . . . , M) during polarity inversion is so large that installing large-sized transmission gates within the decoder 124 is necessary, where each transmission gate typically has a P-type metal oxide semiconductor (PMOS) transistor and an N-type metal oxide semiconductor (NMOS) transistor according to the conventional implementation method. However, at the same time point, there may be only one of the PMOS transistor and the NMOS transistor dominates the operation of the transmission gates and acts as a primary transistor, while the other one acts as a secondary transistor. In other words, at the same time point, about a half of the circuit layout area of the decoder 124 is not utilized effectively.

### SUMMARY OF THE INVENTION

It is therefore an objective of the claimed invention to provide devices and methods for driving liquid crystal display (LCD) panels to solve the above-mentioned problem.

It is another objective of the claimed invention to provide devices and methods for driving LCD panels to reduce the voltage swings during the process of generating gray level voltages, so that the gray level voltages generated by utilizing the claimed invention is more stable than those generated by utilizing the prior art, and the switching speed can be further increased.

It is another objective of the claimed invention to provide devices and methods for driving LCD panels to prevent from using transmission gates during decoding display data, so that the number of transistors utilized during decoding the display data can be reduced to a half of the number of transistors required by the prior art, in order to save the circuit layout area.

According to a preferred embodiment of the claimed invention, a device for driving an LCD panel is disclosed. The device comprises: a gray level voltage generation circuit, for generating a plurality of gray level voltages respectively corresponding to a plurality of gray levels, and determining whether the gray level voltages are generated by utilizing a first set of reference voltages or a second set of reference voltages according to a polarity inversion control signal, where according to the polarity inversion control signal, the gray level voltage generation circuit determines whether a gray level voltage is generated by utilizing a maximum of the first set of reference voltages or a maximum of the second set of reference voltages, and further determines whether another gray level voltage is generated by utilizing a minimum of the first set of reference voltages or a minimum of the second set of reference voltages; and a source driving circuit, coupled to the gray level voltage generation circuit, for selecting a gray level voltage from the plurality of gray level voltages according to display data or inverted data of the display data to drive a source of a display cell of the LCD panel, where the source driving circuit determines whether the gray level voltage is selected by utilizing the display data or the inverted data according to the polarity inversion control signal.

While the device mentioned above is provided, a method for driving an LCD panel is further disclosed according to one embodiment of the claimed invention. The method comprises: generating a plurality of gray level voltages respectively corresponding to a plurality of gray levels, and determining whether the gray level voltages are generated by utilizing a first set of reference voltages or a second set of reference voltages according to a polarity inversion control signal. The step of determining whether the gray level voltages are generated by utilizing the first set of reference voltages or the second set of reference voltages further comprises: according to the polarity inversion control signal, determining whether a gray level voltage is generated by utilizing a maximum of the first set of reference voltages or a maximum of the second set of reference voltages; and according to the polarity inversion control signal, determining whether another gray level voltage is generated by utilizing a minimum of the first set of reference voltages or a minimum of the second set of reference voltages. The method further comprises: selecting a gray level voltage from the plurality of gray level voltages according to display data or inverted data of the display data to drive a source of a display cell of the LCD panel, and determining whether the gray level voltage is selected by utilizing the display data or the inverted data according to the polarity inversion control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a device for driving a liquid crystal display (LCD) panel according to the prior art.

FIG. 2 and FIG. 3 respectively illustrate curves of functions that may have values of candidate gray level voltages shown in FIG. 1 with respect to display data.

FIG. 4 is a diagram of a device for driving an LCD panel according to an embodiment of the present invention.

FIG. 5 is a diagram of the decoder shown in FIG. 4.

FIG. 6 is a diagram of a device for driving an LCD panel according to another embodiment of the present invention.

### DETAILED DESCRIPTION

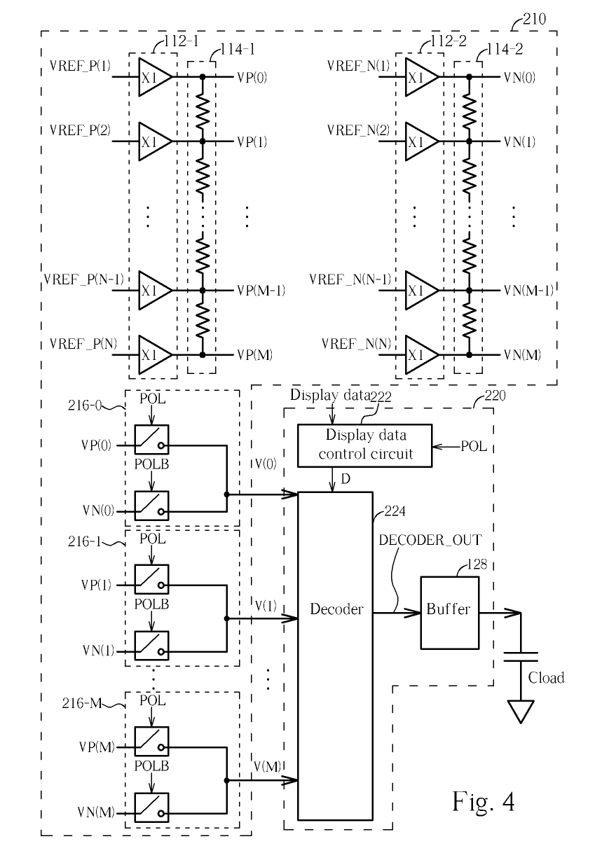

Please refer to FIG. 4. FIG. 4 is a diagram of a device 200 for driving a liquid crystal display (LCD) panel according to an embodiment of the present invention, where the device 200 comprises a gray level voltage generation circuit 210 and a source driving circuit 220, and the LCD panel of the embodiment is a display panel implemented by applying thin film transistor liquid crystal display (TFT-LCD) technologies. In addition, the gray level voltage generation circuit 210 of this embodiment comprises the two sets of buffer amplifiers 112-1 and 112-2 mentioned above, the two sets of gray level resistors 114-1 and 114-2 mentioned above, and switching units 216-0, 216-1, . . . , and 216-M.

According to this embodiment, the first set of buffer amplifiers 112-1 buffer the first set of reference voltages VREF_P(1), VREF_P(2), . . . , VREF_P(N−1), and VREF_P(N) to generate the first set buffered reference voltages at the output terminals of the first set of buffer amplifiers 112-1, while the second set of buffer amplifiers 112-2 buffer the second set of reference voltages VREF_N(1), VREF_N(2), . . . , VREF_N(N−1), and VREF_N(N) to generate the second set buffered reference voltages at the output terminals of the second set of buffer amplifiers 112-2, where the buffered reference voltage processed by a certain buffer amplifier is substantially equivalent to the reference voltage received by the same buffer amplifier. In addition, the first set of gray level resistors 114-1 are arranged in series and coupled to the first set of buffer amplifiers 112-1, in order to generate the first set of candidate gray level voltages VP(0), VP(1), . . . , VP(M−1), and VP(M) according to the first set of buffered reference voltages. Similarly, the second set of gray level resistors 114-2 are arranged in series and coupled to the second set of buffer amplifiers 112-2, in order to generate the second set of candidate gray level voltages VN(0), VN(1), . . . , VN(M−1), and VN(M) according to the second set of buffered reference voltages. As mentioned above, each set of gray level resistors out of the two sets of gray level resistors 114-1 and 114-2 comprise M voltage-dividing resistors arranged in series, where the terminals of these resistors are capable of being utilized for outputting voltages. According to this embodiment, since (M+1)>N, some of the nodes between the voltage-dividing resistors are not directly connected to a buffer amplifier.

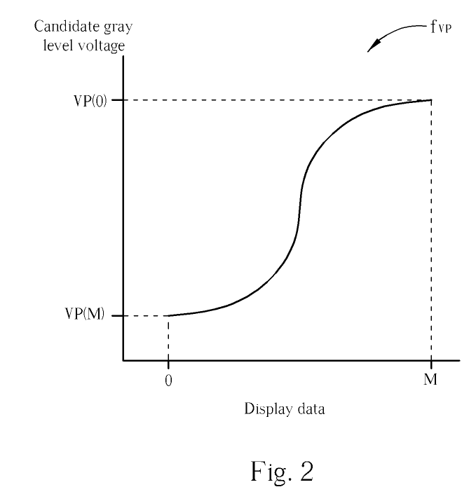

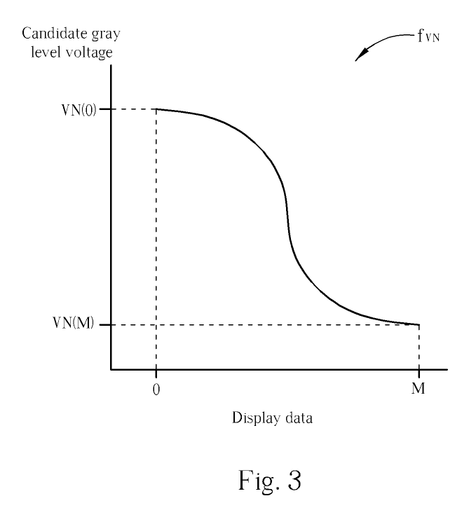

Within this embodiment, the curve of the function f_{VP} that may have the values of the first set of candidate gray level voltages VP(0), VP(1), . . . , VP(M−1), and VP(M) outputted by the first set of gray level resistors 114-1 with respect to the display data is illustrated as shown in FIG. 2, while the curve of the function f_{VN} that may have the values of the second set of candidate gray level voltages VN(0), VN(1), . . . , VN(M−1), and VN(M) outputted by the second set of gray level resistors 114-2 with respect to the display data is illustrated as shown in FIG. 3, where f_{VP}(i)=VP(M−i) and f_{VN}(i)=VN(i) (i=0, 1, . . . , and M).

According to this embodiment, each switching unit 216-i (i=0, 1, . . . , M) is coupled to the candidate gray voltages VP(i) and VN(i) to select a candidate gray level voltage from the candidate gray level voltages VP(i) and VN(i) as a corresponding gray level voltage V(i) according to the polarity inversion control signal POL and its inverted signal POLB. As a result, the device 200 and the corresponding method provided by this embodiment of the present invention can determine whether the plurality of gray level voltages V(0), V(1), . . . , and V(M) shown in FIG. 4 is generated by utilizing the first set of reference voltages VREF_P(1), VREF_P(2), . . . , VREF_P(N−1), and VREF_P(N) or the second set of reference voltages VREF_N(1), VREF_N(2), . . . , VREF_N(N−1), and VREF_N(N) according to the polarity inversion control signal POL. In addition, according to the polarity inversion control signal POL, the gray level voltage generation circuit 210 determines whether a gray level voltage V(0) is generated by utilizing the maximum voltage VREF_P(1) of the first set of reference voltages VREF_P(1), VREF_P(2), . . . , VREF_P(N−1), and VREF_P(N) or the maximum voltage VREF_N(1) of the second set of reference voltages VREF_N(1), VREF_N(2), . . . , VREF_N(N−1), and VREF_N(N) according to the polarity inversion control signal POL, and further determines whether another gray level voltage V(M) is generated by utilizing the minimum voltage VREF_P(N) of the first set of reference voltages VREF_P(1), VREF_P(2), VREF_P(N−1), and VREF_P(N) or the minimum voltage VREF_N(N) of the second set of reference voltages VREF_N(1), VREF_N(2), . . . , VREF_N(N−1), and VREF_N(N). Besides, according to the polarity inversion control signal POL, the gray level voltage generation circuit 210 can further determine whether one specific gray level voltage of the plurality of gray level voltages V(0), V(1), . . . , and V(M) is generated by utilizing a first voltage of the first set of reference voltages VREF_P(1), VREF_P(2), . . . , VREF_P(N−1), and VREF_P(N) or a second voltage of the second set of reference voltages VREF_N(1), VREF_N(2), . . . , VREF_N(N−1), and VREF_N(N), where the first voltage is substantially equivalent to the second voltage in this embodiment. For example, the specific gray level voltage, the first voltage and the second voltage are respectively the gray level voltage V(1), the reference voltage VREF_P(2) and the reference voltage VREF_N(2).

Please note that, according to the curve of the function f_{VP} as illustrated in FIG. 2 and the curve of the function f_{VN} as illustrated in FIG. 3, the candidate gray level voltage VP(i) selected by each switching unit 216-i on one polarity (which is the positive polarity in this embodiment) is very close to the candidate gray level voltage VN(i) selected by the same switching unit 216-i on the other polarity (which is the negative polarity in this embodiment). More particularly, in this embodiment, the candidate gray level voltage VP(i) of the positive polarity is substantially equivalent to the candidate gray level voltage VN(i) of the negative polarity. Hence, in contrast to the prior art, the device 200 and the corresponding method provided by the embodiment of the present invention can minimize the voltage swings during the process of generating the gray level voltages, so that the gray level voltages generated according to the present invention are more stable than those generated according to the prior art, and the switching speed can be further increased.

According to this embodiment, one set of candidate gray level voltages out of the two sets of candidate gray level voltages are selected as the gray level voltages V(0), V(1), . . . , and V(M) according to the polarity represented by the polarity inversion control signal POL, in order to be transmitted to the source driving circuits of respective display units of the LCD panel, such as the source driving circuit 220, where Cload represents the equivalent capacitance of the display cell driven by the source driving circuit 220.

The source driving circuit 220 of this embodiment comprises a display data control circuit 222, a decoder 224, and the above-mentioned buffer 128, where according to the display data, the decoder 124 selects a gray level voltage out of the gray level voltages V(0), V(1), . . . , and V(M) and outputs the selected gray level voltage (i.e., the gray level voltage DECODER_OUT shown in FIG. 4 in the embodiment), and then performs buffering operations on the selected gray level voltage from the decoder 124 by utilizing the buffer 128 to drive the corresponding load within the LCD panel, i.e., the above-mentioned equivalent capacitance Cload. Furthermore, the operations of the display data control circuit 222 is designed in accordance with the coupling relationships between the switching unit 216-i (i=0, 1, . . . , and M) and the candidate gray level voltages VP(i) and VN(i). In this embodiment, according to the polarity inversion control signal POL, the display data control circuit 222 can determine whether to invert the display data to generate the inverted display data or bypass the display data. For example, if the binary value of the display data is equal to 111111, the binary value of the inverted data is equal to 000000.

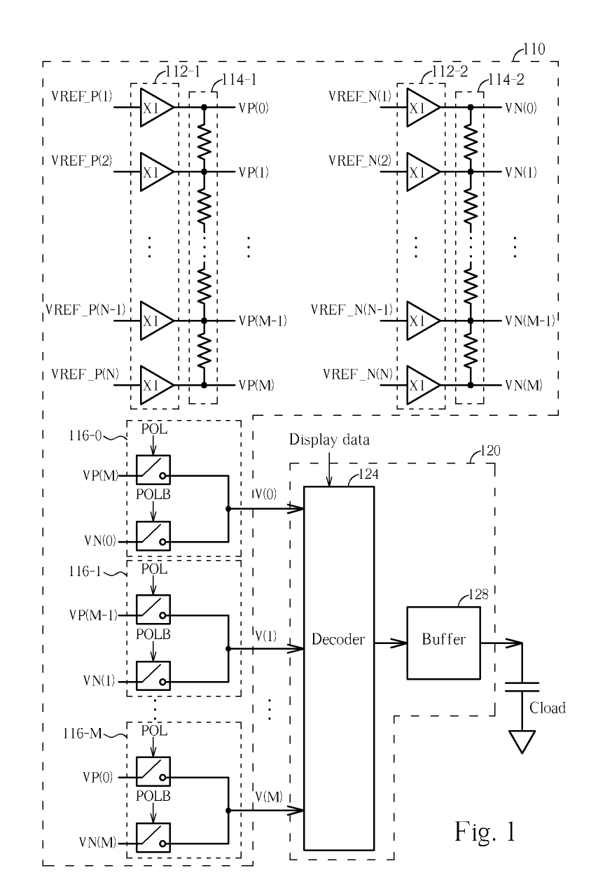

According to this embodiment, if the polarity inversion control signal POL is at a high voltage level (meaning logic 1 here) while the inverted signal POLB is at a low voltage level, the output data D outputted by the display data control circuit 222 is the inverted display data. Conversely, if the polarity inversion control signal POL is at a low voltage level (meaning logic 0 here) while the inverted signal POLB is at a high voltage level, the output data D outputted by the display data control circuit 222 is still the display data. As a result, the display data control circuit 222 outputs the display data or the inverted data as the output data D in accordance with the polarity inversion control signal POL and its inverted signal POLB, so according to the output data D (which is the bypassed display data or the inverted data here), the decoder 224 can select from a plurality of gray level voltages the gray level voltage (e.g. the gray level voltage DECODER_OUT shown in FIG. 4 in the embodiment) and output the selected gray level voltage. Thus, the same decoded result as that of the device 100 shown in FIG. 1 can be generated.

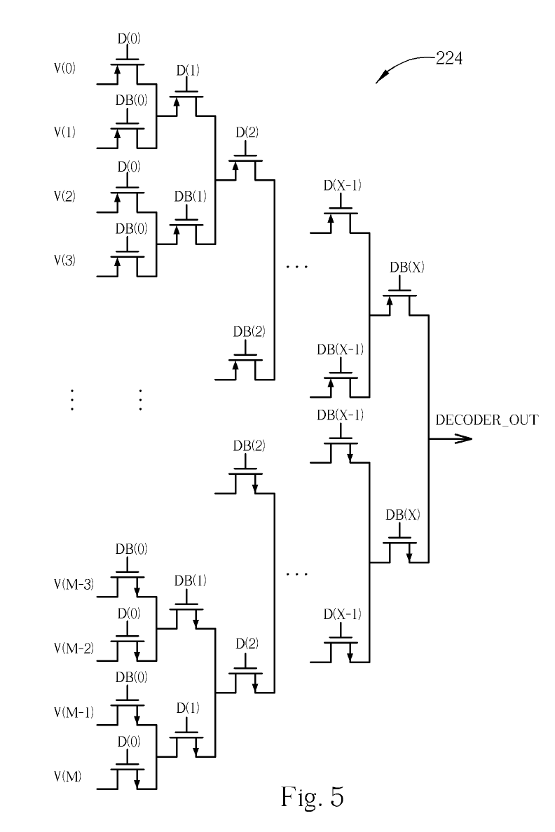

FIG. 5 is a diagram of the decoder 224 shown in FIG. 4, where D(0), D(1), . . . , D(X) represent (X+1) bits of the output data D, and DB(0), DB(1), . . . , DB(X) represent inverted bits of the (X+1) bits of the output data D. For example, if bit D(0) is logic 1, its inverted bit DB(0) is logic 0. According to the coupling relationships of the switching unit 216-0, 216-1, . . . , and 216-M within the embodiment, as the voltage swing of each of the gray level voltages V(0), V(1), . . . , and V(M) during polarity switching is small, and as a first set of transistors of the upper part of the decoder 224 are utilized for decoding higher voltages (e.g. V(0), V(1), . . . , and V((M−1)/2) in this embodiment) while a second set of transistors of the lower part of the decoder 224 are utilized for decoding lower voltages (e.g. V((M+1)/2), V((M+3)/2), . . . , and V(M) in this embodiment), the first set of transistors of the upper part of the decoder 224 can be implemented by utilizing PMOS transistors while the second set of transistors of the lower part of the decoder 224 can be implemented by utilizing NMOS transistors, as shown in FIG. 5. As a result, no transmission gate as suggested by the prior art will be used during decoding the display data according to this embodiment, so that the number of transistors utilized during decoding the display data can be reduced to a half of the number of transistors required by the prior art to save the circuit layout area.

For example, if M=63, the number of transmission gates required for implementing the decoder 124 shown in FIG. 1 is at least:

(32+16+8+4+2+1)*2=63*2=126;

where each transmission gate has a PMOS transistor and an NMOS transistor. In contrast to the decoder 124 shown in FIG. 1, if M=63, 63 NMOS transistors can be saved while implementing the upper part of the decoder 224, and 63 PMOS transistors can be saved while implementing the lower part of the decoder 224.

According to a variation of this embodiment, each switching unit 216-i (i=0, 1, . . . , M) is coupled to candidate gray level voltages VP(M−i) and VN(M−i) to select a candidate gray level voltage as a corresponding gray level voltage V(i) from the candidate gray level voltages VP(M−i) and VN(M−i) according to the polarity inversion control signal POL and its inverted signal POLB. According to this variation, if the polarity inversion control signal POL is at a high voltage level while the inverted signal POLB is at a low voltage level, the output data D outputted by the display data control circuit 222 is still the display data. Conversely, if the polarity inversion control signal POL is at a low voltage level while the inverted signal POLB is at a high voltage level, the output data D outputted by the display data control circuit 222 is the inverted display data. Similar descriptions for this variation are not repeated in detail.

According to another variation of this embodiment, at least a portion of the source driving circuit 220 can be integrated into a single module regarding layout. For example, two or all elements of the display data control circuit 222, the decoder 224, and the buffer 128 can be integrated into a single module.

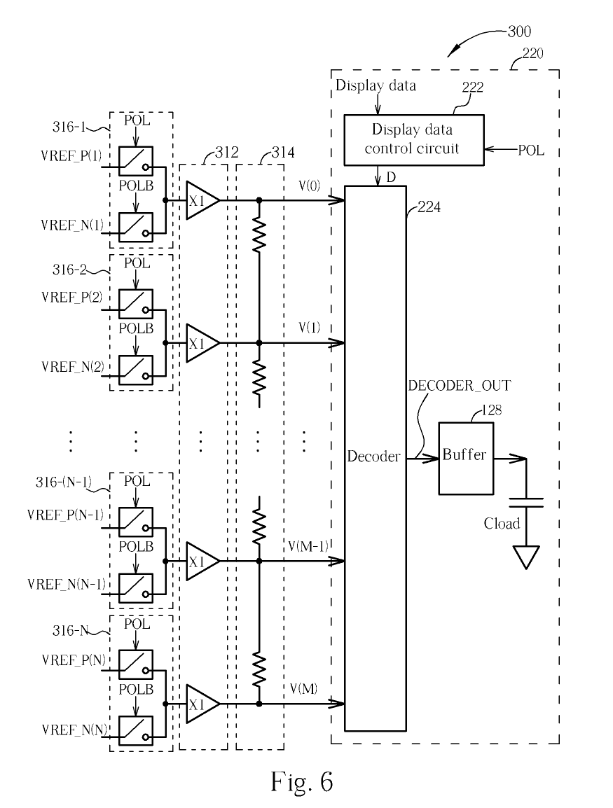

FIG. 6 is a diagram of the device 300 for driving an LCD panel according to another embodiment of the present invention. This embodiment is a variation of the embodiment shown in FIG. 4, where the switching units 316-1, 316-2, . . . , 316-(N−1), and 316-N are installed and positioned closely next to the two sets of reference voltages to directly select one set of reference voltages from the two sets of reference voltages, so that only one set of buffer amplifiers 112 and only one set of gray level resistors 114 are required for implementing according to this embodiment. Similar descriptions for this embodiment are not repeated in detail.

Those skilled in the art will readily observe that numerous modifications and alterations of the device and method may be made while retaining the teachings of the invention.

What is claimed is:

1. A device for driving a liquid crystal display (LCD) panel, comprising:
a gray level voltage generation circuit, for generating a plurality of gray level voltages respectively corresponding to a plurality of gray levels, and determining whether the gray level voltages are generated by utilizing a first set of reference voltages or a second set of reference voltages according to a polarity inversion control signal, wherein according to the polarity inversion control signal, the gray level voltage generation circuit determines whether a gray level voltage is generated by utilizing a maximum of the first set of reference voltages or a maximum of the second set of reference voltages, and further determines whether another gray level voltage is generated by utilizing a minimum of the first set of reference voltages or a minimum of the second set of reference voltages; and
a source driving circuit, coupled to the gray level voltage generation circuit, for selecting a gray level voltage from the plurality of gray level voltages according to display data or inverted data of the display data to drive a source of a display cell of the LCD panel, wherein the source driving circuit determines whether the gray level voltage is selected by utilizing the display data or the inverted data according to the polarity inversion control signal.

2. The device of claim 1, wherein the gray level voltage generation circuit determines whether a specific gray level voltage of the gray level voltages is generated by utilizing a first voltage of the first set of reference voltages or a second voltage of the second set of reference voltages according to the polarity inversion control signal; and the first voltage is substantially equivalent to the second voltage.

3. The device of claim 1, wherein the gray level voltage generation circuit comprises:
a first set of buffer amplifiers, for respectively buffering the first set of reference voltages to generate a first set of buffered reference voltages;
a second set of buffer amplifiers, for respectively buffering the second set of reference voltages to generate a second set of buffered reference voltages;
a first set of gray level resistors, arranged in series and coupled to the first set of buffer amplifiers, for generating a first set of candidate gray level voltages according to the first set of buffered reference voltages;
a second set of gray level resistors, arranged in series and coupled to the second set of buffer amplifiers, for generating a second set of candidate gray level voltages according to the second set of buffered reference voltages; and
a plurality of switching units, coupled to the first set of gray level resistors and the second set of gray level resistors, for selecting the first set of candidate gray level voltages or the second set of candidate gray level voltages as the plurality of gray level voltages according to the polarity inversion control signal.

4. The device of claim 1, wherein the gray level voltage generation circuit comprises:
a plurality of switching units, for selecting the first set of reference voltages or the second set of reference voltages as a set of selected reference voltages according to the polarity inversion control signal;
a set of buffer amplifiers, respectively coupled to the plurality of switching units, for respectively buffering the set of selected reference voltages to generate a set of buffered reference voltages; and
a set of gray level resistors, arranged in series and coupled to the set of buffer amplifiers, for generating the plurality of gray level voltages according to the set of buffered reference voltages.

5. The device of claim 1, wherein the source driving circuit comprises:
a display data control circuit, for determining whether to invert the display data according to the polarity inversion control signal to generate the inverted data or bypass the display data; and
a decoder, coupled to the display data control circuit and the gray level voltage generation circuit, for selecting the gray level voltage from the plurality of gray level voltages according to the bypassed display data or the inverted data.

6. The device of claim 5, wherein the decoder comprises a plurality of transistors, coupled to the display data control circuit and the gray level voltage generation circuit, for selecting the gray level voltage from the plurality of gray level voltages according to the bypassed display data or the inverted data; and the plurality of transistors comprises:
a first set of transistors, for performing selection operations on a plurality of higher voltages within the plurality of gray level voltages; and
a second set of transistors, for performing selection operations on a plurality of lower voltages within the plurality of gray level voltages;
wherein the first set of transistors do not perform selection operations on the plurality of lower voltages, and the second set of transistors do not perform selection operations on the plurality of higher voltages.

7. The device of claim 6, wherein the first set of transistors are P-type metal oxide semiconductor (PMOS) transistors, and the second set of transistors are N-type metal oxide semiconductor (NMOS) transistors.

8. The device of claim 5, wherein the source driving circuit further comprises:
a buffer, coupled to the decoder, for buffering the gray level voltage.

9. The device of claim 5, wherein at least a portion of the source driving circuit is integrated into a single module regarding layout.

10. The device of claim 5, wherein if the display data control circuit inverts the display data to generate the inverted data, the decoder selects the gray level voltage from the plurality of gray level voltages according to the inverted data, and the plurality of gray level voltages are generated by utilizing the first set of reference voltages; and if the display data control circuit bypasses the display data, the decoder selects the gray level voltage from the plurality of gray level voltages according to the bypassed display data, and the plurality of gray level voltages are generated by utilizing the second set of reference voltages.

11. A method for driving a liquid crystal display (LCD) panel, comprising:
generating a plurality of gray level voltages respectively corresponding to a plurality of gray levels, and determining whether the gray level voltages are generated by utilizing a first set of reference voltages or a second set of reference voltages according to a polarity inversion control signal, wherein the step of determining whether the gray level voltages are generated by utilizing the first set of reference voltages or the second set of reference voltages further comprises:
according to the polarity inversion control signal, determining whether a gray level voltage is generated by utilizing a maximum of the first set of reference voltages or a maximum of the second set of reference voltages; and
according to the polarity inversion control signal, determining whether another gray level voltage is generated by utilizing a minimum of the first set of reference voltages or a minimum of the second set of reference voltages; and
selecting a gray level voltage from the plurality of gray level voltages according to display data or inverted data of the display data to drive a source of a display cell of the LCD panel, and determining whether the gray level voltage is selected by utilizing the display data or the inverted data according to the polarity inversion control signal.

12. The method of claim 11, wherein the step of determining whether the gray level voltages are generated by utilizing the first set of reference voltages or the second set of reference voltages further comprises:
determining whether a specific gray level voltage of the gray level voltages is generated by utilizing a first voltage of the first set of reference voltages or a second voltage of the second set of reference voltages according to the polarity inversion control signal, wherein the first voltage is substantially equivalent to the second voltage.

13. The method of claim 11, wherein the step of generating the plurality of gray level voltages respectively corresponding to the plurality of gray levels further comprises:
buffering the first set of reference voltages to generate a first set of buffered reference voltages;
buffering the second set of reference voltages to generate a second set of buffered reference voltages;
generating a first set of candidate gray level voltages by utilizing a first set of gray level resistors arranged in series according to the first set of buffered reference voltages; and
generating a second set of candidate gray level voltages by utilizing a second set of gray level resistors arranged in series according to the second set of buffered reference voltages;
wherein the step of determining whether the gray level voltages are generated by utilizing the first set of reference voltages or the second set of reference voltages further comprises:
selecting the first set of candidate gray level voltages or the second set of candidate gray level voltages as the plurality of gray level voltages according to the polarity inversion control signal.

14. The method of claim 11, wherein the step of determining whether the gray level voltages are generated by utilizing the first set of reference voltages or the second set of reference voltages further comprises:
selecting the first set of reference voltages or the second set of reference voltages as a set of selected reference voltages according to the polarity inversion control signal;
wherein the step of generating the plurality of gray level voltages respectively corresponding to the plurality of gray levels further comprises:
respectively buffering the set of selected reference voltages to generate a set of buffered reference voltages; and
generating the plurality of gray level voltages by utilizing a set of gray level resistors arranged in series according to the set of buffered reference voltages.

15. The method of claim 11, wherein the step of selecting the gray level voltage from the plurality of gray level voltages further comprises:
determining whether to invert the display data according to the polarity inversion control signal to generate the inverted data or bypass the display data; and
selecting the gray level voltage from the plurality of gray level voltages according to the bypassed display data or the inverted data.

16. The method of claim 15, wherein the step of selecting the gray level voltage from the plurality of gray level voltages further comprises:
providing a first set of transistors for performing selection operations on a plurality of higher voltages within the plurality of gray level voltages; and
providing a second set of transistors for performing selection operations on a plurality of lower voltages within the plurality of gray level voltages;
wherein the first set of transistors do not perform selection operations on the plurality of lower voltages, and the second set of transistors do not perform selection operations on the plurality of higher voltages.

17. The method of claim 16, wherein the first set of transistors are P-type metal oxide semiconductor (PMOS) transistors, and the second set of transistors are N-type metal oxide semiconductor (NMOS) transistors.

18. The method of claim 15, wherein step of selecting the gray level voltage from the plurality of gray level voltages to drive the source of the display cell of the LCD panel further comprises:
buffering the gray level voltage.

19. The method of claim 15, wherein if the step of selecting the gray level voltage from the plurality of gray level voltages inverts the display data to generate the inverted data, the gray level voltage is selected from the plurality of gray level voltages further according to the inverted data, and the plurality of gray level voltages are generated by utilizing the first set of reference voltages; and if the step of selecting the gray level voltage from the plurality of gray level voltages bypasses the display data, the gray level voltage is selected from the plurality of gray level voltages further according to the bypassed display data, and the plurality of gray level voltages are generated by utilizing the second set of reference voltages.
